(19) United States
(12) Patent Application Publication
(10) Pub. No.: US 2017/0115765 A1
(43) Pub. Date: Apr. 27, 2017

(54) INTERACTION WITH SURFACE ACOUSTIC WAVE TOUCHSCREENS

(71) Applicant: Hewlett-Packard Development Company, L.P., Houston, TX (US)

(72) Inventors: Juliano Godinho Varaschin de MORAES, Mountain View, CA (US); Binh TRUONG, Sunnyvale, CA (US); Carol OZAKI, Cupertino, CA (US)

(21) Appl. No.: 15/129,381

(22) PCT Filed: Mar. 31, 2014
(86) PCT No.: PCT/US2014/032376

§ 371 Date: Sep. 26, 2016

(51) Int. Cl. G06F 3/043; G06F 3/041

(52) U.S. Cl. CPC G06F 3/043; G06F 3/0416; G06F 3/04842

(57) ABSTRACT

Example implementations relate to interacting with a surface acoustic wave (SAW) touchscreen. In example implementations, a selection of an area of a SAW touchscreen may be received. A plurality of ultrasonic waves may be transmitted to the SAW touchscreen. The plurality of ultrasonic waves may disrupt sound waves, that are propagating across the SAW touchscreen, in substantially the same manner as physically touching the SAW touchscreen at the selected area.

### BACKGROUND

Surface acoustic wave (SAW) touchscreens may be used as displays for various user devices, such as televisions and personal computers. A SAW touchscreen may include ultrasonic wave transmitters, ultrasonic wave sensors or receivers, and ultrasonic wave reflectors. The transmitters may generate ultrasonic waves that propagate along the surface of the SAW touchscreen, are reflected by the reflectors, and are received by the sensors/receivers. When a human user touches a SAW touchscreen with his/her finger, the finger absorbs some of the ultrasonic waves along the surface of the SAW touchscreen and the absorbed waves are not received by the sensors/receivers. Processing circuitry of the SAW touchscreen may be used to determine where the SAW touchscreen was touched.

### BRIEF DESCRIPTION OF THE DRAWINGS

The following detailed description references the drawings, wherein:

FIG. 1 is a block diagram of an example remote control device that includes a machine-readable storage medium encoded with instructions that enable remote interaction with surface acoustic wave (SAW) touchscreens;

FIG. 2 is a block diagram of an example remote control device that includes a machine-readable storage medium encoded with instructions to enable sending data via ultrasonic waves to SAW touchscreens;

FIG. 3 is a block diagram of an example remote control device that includes a machine-readable storage medium encoded with instructions to automatically direct ultrasonic waves at a desired area of a SAW touchscreen;

FIG. 4 is a block diagram of an example remote control device that includes a machine-readable storage medium encoded with instructions to enable remote selection of a desired area of a SAW touchscreen;

FIG. 5 is a block diagram of an example device that includes a machine-readable storage medium encoded with instructions to decode an ultrasonic wave pattern to obtain data

FIG. 6 is a block diagram of an example device that includes a machine-readable storage medium encoded with instructions to enable displaying a web page in response to a decoded ultrasonic wave pattern;

FIG. 7 is a flowchart of an example method for interacting with SAW touchscreens;

FIG, 8 is a flowchart of an example method for sending data via ultrasonic waves to SAW touchscreens;

FIG. 9 is a flowchart of an example method for automatically directing ultrasonic waves at a desired area of a SAW touchscreen; and

FIG. 10 is a flowchart of an example method for modifying, based on data encoded in ultrasonic waves, what is displayed on a SAW touchscreen.

### DETAILED DESCRIPTION

Surface acoustic wave (SAW) touchscreens may respond when physically touched at a particular area. For example, in response to a touch at an area where an icon is displayed, an application may be opened or drop-down menu options may be displayed. Some people who desire to use SAW touchscreens may not be able to touch them. For example, a person may not be tall enough to reach a mounted SAW touchscreen, or may be too far away from a SAW touchscreen to physically touch it.

In light of the above, the present disclosure provides for remote interaction with SAW touchscreens. Ultrasonic waves may be transmitted from a remote control device to a SAW touchscreen such that the transmitted ultrasonic waves simulate a touch at a certain area of the SAW touchscreen. Thus, a user may be able to interact with a SAW touchscreen even if the user is not able to physically touch the SAW touchscreen.

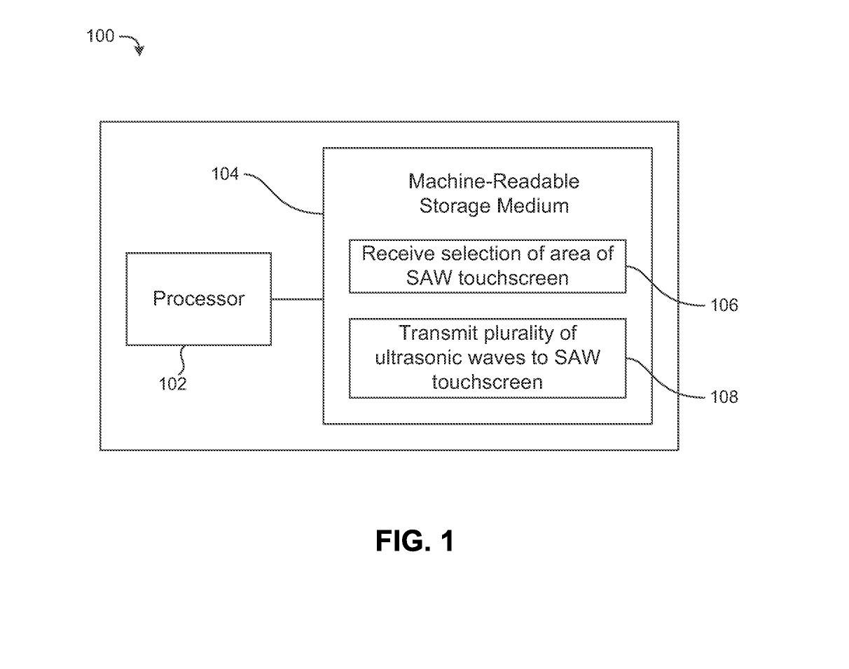

Referring now to the drawings, FIG. 1 is a block diagram of an example remote control device 100 that includes a machine-readable storage medium encoded with instructions that enable remote interaction with SAW touchscreens, As used herein, the terms “include”, “have”, and “comprise” are interchangeable and should be understood to have the same meaning. In some implementations, remote control device 100 may be implemented as a stand-alone device. For example, remote control device 100 may be a hand-held device that includes an ultrasonic transmitter, and that may be controlled by pressing hard and/or soft keys. In some implementations, remote control device 100 may be implemented using a mobile device. For example, a peripheral device that includes an ultrasonic transmitter may be plugged into a headphone jack, Universal Serial Bus (USB) port, or other port of a mobile device (e.g., smart phone, tablet) and controlled using an application on the mobile device.

In FIG. 1, remote control device 100 includes processor 102 and machine-readable storage medium 104. Processor 102 may include a central processing unit (CPU), microprocessor (e.g., semiconductor-based microprocessor), and/or other hardware device suitable for retrieval and/or execution of instructions stored in machine-readable storage medium 104. Processor 102 may fetch, decode, and/or execute instructions 106 and 108 to enable remote interaction with SAW touchscreens, as described below. As an alternative or in addition to retrieving and/or executing instructions, processor 102 may include an electronic circuit comprising a number of electronic components for performing the functionality of instructions 106 and/or 108.

Machine-readable storage medium 104 may be any suitable electronic, magnetic, optical, or other physical storage device that contains or stores executable instructions. Thus, machine-readable storage medium 104 may include, for example, a random-access memory (RAM), an Electrically Erasable Programmable Read-Only Memory (EEPROM), a storage device, an optical disc, and the like. In some implementations, machine-readable storage medium 104 may include a non-transitory storage medium, where the term “non-transitory” does not encompass transitory propagating signals. As described in detail below, machine-readable storage medium 104 may be encoded with a set of executable instructions 106 and 108.

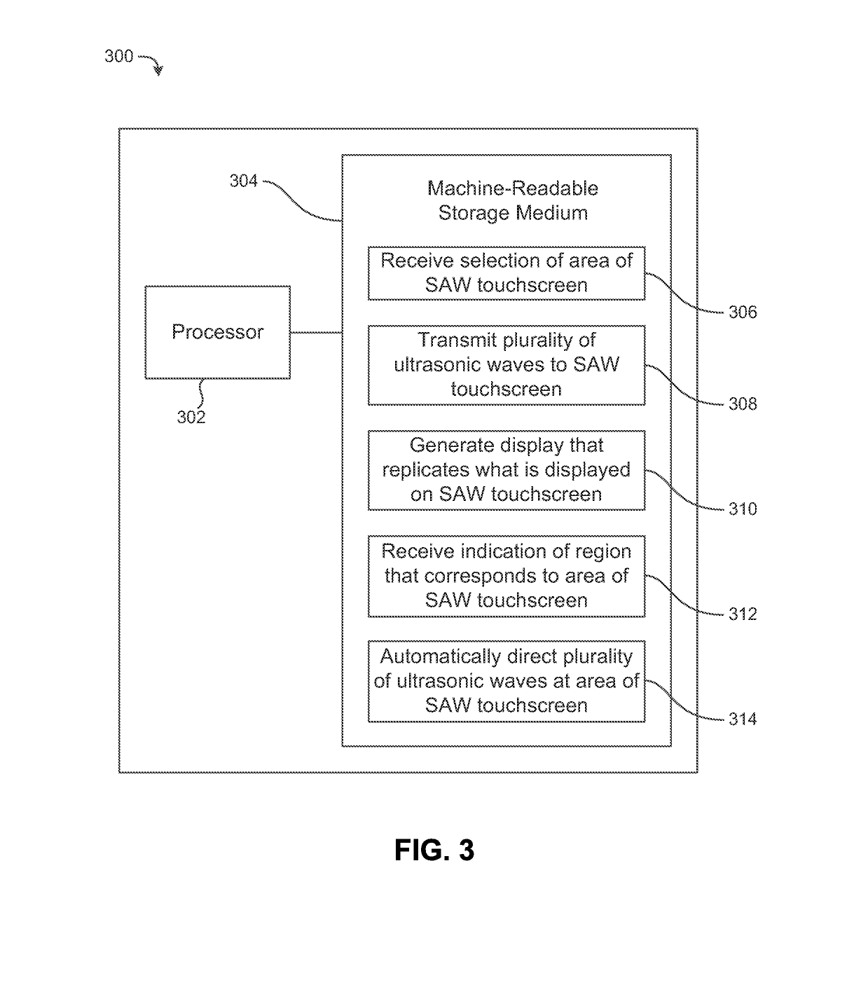

Instructions 106 may receive a selection of an area of a SAW touchscreen. In some implementations, a user may point an ultrasonic emitter of remote control device 100 at an area of the SAW touchscreen. In some implementations, a user may enter coordinates using a remote control device (e.g., remote control device 100) to specify a desired area of the SAW touchscreen. In some implementations, an area of the SAW touchscreen may be selected by selecting a corresponding region of a display of the remote control device, as discussed further with respect to FIG. 3. Any other suitable method for selecting an area of the SAW touchscreen may be used.

Instructions 108 may transmit a plurality of ultrasonic waves to a SAW touchscreen. The plurality of ultrasonic waves may disrupt sound waves, that are propagating across the SAW touchscreen, in substantially the same manner as physically touching the SAW touchscreen at the selected area. As used herein, the term “substantially the same manner”, as used with respect to an area of a SAW touchscreen and to effects of transmitted ultrasound waves on waves propagating across the SAW touchscreen, should be understood to mean disrupting waves along the surface of the SAW touchscreen in such a way that causes the SAW touchscreen to respond as if the SAW touchscreen had been physically touched at the area.

For example, physically touching the SAW touchscreen at the area with a finger may prevent some of the waves propagating across the SAW touchscreen from being received by a sensor along an edge of the SAW touchscreen because the finger may absorb some of the waves, and processing circuitry of the SAW touchscreen may determine where the absorption occurred, and thus determine where the SAW touchscreen was touched. The SAW touchscreen may respond to such a determination by, for example, opening an application, closing an application, minimizing/maximizing a window, etc. To achieve the same result without physically touching the SAW touchscreen, ultrasonic waves may be transmitted to the SAW touchscreen and may deflect some waves propagating across the SAW touchscreen to simulate absorption, preventing such waves from being received by the sensor.

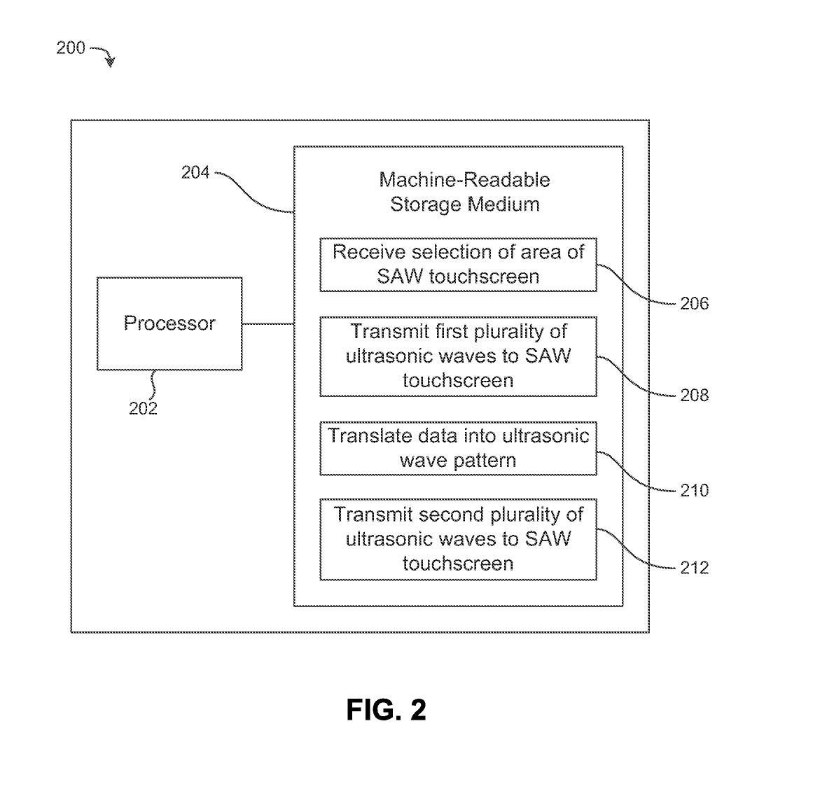

FIG, 2 is a block diagram of an example remote control device 200 that includes a machine-readable storage medium encoded with instructions to enable sending data via ultrasonic waves to SAW touchscreens. Remote control device 200 may be implemented as a stand-alone device or using a mobile device, as discussed above with respect to FIG. 1. In FIG. 2, remote control device 200 includes processor 202 and machine-readable storage medium 204.

As with processor 102 of FIG. 1, processor 202 may include a CPU, microprocessor (e.g., semiconductor-based microprocessor), and/or other hardware device suitable for retrieval and/or execution of instructions stored in machine-readable storage medium 204. Processor 202 may fetch, decode, and/or execute instructions 206, 208, 210, and 212 to enable sending data via ultrasonic waves to SAW touchscreens, as described below. As an alternative or in addition to retrieving and/or executing instructions, processor 202 may include an electronic circuit comprising a number of electronic components for performing the functionality of instructions 206, 208, 210, and/or 212.

As with machine-readable storage medium 104 of FIG. 1, machine-readable storage medium 204 may be any suitable physical storage device that stores executable instructions. Instructions 206 and 208 on machine-readable storage medium 204 may be analogous to (e.g., have functions and/or components similar to) instructions 106 and 108 on machine-readable storage medium 104. Instructions 208 may transmit a first plurality of ultrasonic waves to a SAW touchscreen to enable remote selection of an area of the SAW touchscreen, as discussed above with respect to FIG. 1. Instructions 210 may translate data into an ultrasonic wave pattern. Data may include, for example, a uniform resource identifier (URI), a message, and/or a command (e.g., to open/close an application, to bring the SAW touchscreen into or out of a sleep mode). The ultrasonic wave pattern may include multiple frequencies (e.g., frequency modulation may be used to encode data). hi some implementations, the multiple frequencies may simulate binary code; a first frequency may represent logical ‘0’ and a second frequency may represent logical ‘1’, or vice-versa. In some implementations, the multiple frequencies may simulate a version of Morse code; a first frequency may represent a dot and a second frequency may represent a dash, or vice-versa

Data that is translated into an ultrasonic wave pattern may be obtained in various ways. In some implementations, a remote control device (e.g., remote control device 200) may include a hard or soft keypad that a user may use to type in a desired URI or text message. In implementations where the remote control device is implemented using a mobile device, an application on the mobile device may automatically translate the URI or text message into an ultrasonic wave pattern. In some implementations, the remote control device may include various hard or soft keys that correspond to different commands for a SAW touchscreen, and when a user presses a key the corresponding command may automatically be translated into an ultrasonic wave pattern. Any other suitable method for obtaining data may be used.

Instructions 212 may transmit a second plurality of ultrasonic waves to a SAW touchscreen. The second plurality of ultrasonic waves may include the ultrasonic wave pattern translated by instructions 210. As discussed above, the ultrasonic wave pattern may include multiple frequencies. Different frequencies may have different disruptive effects on waves propagating across the SAW touchscreen. Processing circuitry of the SAW touchscreen may detect a series of wave disruptions and determine which frequencies were transmitted that caused the disruptions, and thus decode data in the ultrasonic wave pattern. The SAW touchscreen may modify, based on the decoded data, what is displayed on the SAW touchscreen. For example, the second plurality of ultrasonic waves may be used to transmit a URI (e.g., the URI may be encoded in an ultrasonic wave pattern in the second plurality of ultrasonic waves) to the SAW touchscreen, The SAW touchscreen may display, in response to receiving the second plurality of ultrasonic waves, a web page to which the URI refers.

FIG, 3 is a block diagram of an example remote control device 300 that includes a machine-readable storage medium encoded with instructions to automatically direct ultrasonic waves at a desired area of a SAW touchscreen. Remote control device 300 may be implemented as a stand-alone device or using a mobile device, as discussed above with respect to FIG, 1. In FIG. 3, remote control device 300 includes processor 302 and machine-readable storage medium 304.

As with processor 102 of FIG. 1, processor 302 may include a CPU, microprocessor (e.g., semiconductor-based microprocessor), and/or other hardware device suitable for retrieval and/or execution of instructions stored in machine-readable storage medium 304. Processor 302 may fetch, decode, and/or execute instructions 306, 308, 310, 312, and 314. As an alternative or in addition to retrieving and/or executing instructions, processor 302 may include an electronic circuit comprising a number of electronic components for performing the functionality of instructions 306, 308, 310, 312, and/or 314.

As with machine-readable storage medium 104 of FIG. 1, machine-readable storage medium 304 may be any suitable physical storage device that stores executable instructions. Instructions 306 and 308 on machine-readable storage medium 304 may be analogous to instructions 106 and 108 on machine-readable storage medium 104. Instructions 310 may generate a display that replicates what is displayed on the SAW touchscreen. For example, a remote control device (e.g., remote control device 300) may display what looks like a screen shot of what is displayed on the SAW touchscreen. In some implementations, due to differences in display capabilities between the SAW touchscreen and the remote control device, the resolution and/or aspect ratio of what is displayed on the remote control device may be different from what is displayed on the SAW touchscreen. The term “replicates” as used herein should be understood to include such variances due to differing display capabilities.

Instructions 312 may receive an indication of a region, of the display generated by instructions 310, that corresponds to an area of the SAW touchscreen. For example, various icons displayed on the SAW touchscreen may also be displayed on the remote control device, and a user may select (e.g., using a finger, stylus, or cursor), on the display of the remote control device, an icon that corresponds to the icon the user desires to select on the SAW touchscreen. In some implementations, the remote control device may display a screen shot of what is displayed on the SAW touchscreen, and a user may select (e.g., using a finger, stylus, or cursor) a region of the screen shot that corresponds to an area of the SAW touchscreen that the user desires to select.

Instructions 314 may automatically direct a plurality of ultrasonic waves at the area of the SAW touchscreen corresponding to the indicated region. For example, after a user selects an icon/region on a display of the remote control device, instructions 314 may automatically transmit, without further action from the user (e.g., without the user having to press a hard/soft key to initiate transmission of the ultrasonic waves), a plurality of ultrasonic waves directed at the corresponding area of the SAW touchscreen. In some implementations, the remote control device may determine (e.g., using a camera and/or wireless signals) where the SAW touchscreen is in relation to an ultrasonic emitter of the remote control device, and instructions 314 may automatically focus and transmit the plurality of ultrasonic waves at the appropriate area of the SAW touchscreen without the user having to aim the remote control device.

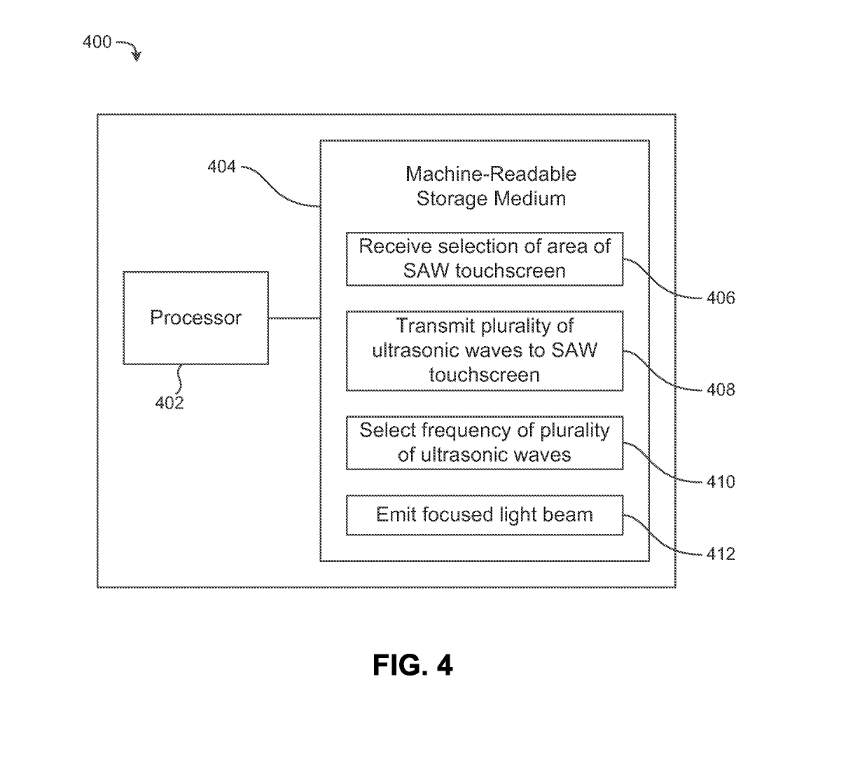

FIG. 4 is a block diagram of an example remote control device 400 that includes a machine-readable storage medium encoded with instructions to enable remote selection of a desired area of a SAW touchscreen. Remote control device 400 may be implemented as a stand-alone device or using a mobile device, as discussed above with respect to FIG. 1. In FIG. 4, remote control device 400 includes processor 402 and machine-readable storage medium 404.

As with processor 102 of FIG. 1, processor 402 may include a CPU, microprocessor (e.g., semiconductor-based microprocessor), and/or other hardware device suitable for retrieval and/or execution of instructions stored in machine-readable storage medium 404. Processor 402 may fetch, decode, and/or execute instructions 406, 408, 410, and 412 to enable sending data via ultrasonic waves to SAW touchscreens, as described below. As an alternative or in addition to retrieving and/or executing instructions, processor 402 may include an electronic circuit comprising a number of electronic components for performing the functionality of instructions 406, 408, 410, and/or 412.

As with machine-readable storage medium 104 of FIG. 1, machine-readable storage medium 404 may be any suitable physical storage device that stores executable instructions. Instructions 406 and 408 on machine-readable storage medium 404 may be analogous to instructions 106 and 108 on machine-readable storage medium 104. Instructions 410 may select a frequency of a plurality of ultrasonic waves. The selected frequency may be in a range of frequencies to which a SAW touchscreen is responsive. In some implementations, a remote control device (e.g., remote control device 400) may transmit a series of ultrasonic pulses, starting with the lowest frequency that the remote control device is capable of transmitting and increasing the frequency for each subsequent pulse until the highest frequency that the remote control device is capable of transmitting is reached, and determine which frequency (or frequencies) the SAW touchscreen acknowledges and/or to which frequency (or frequencies) the SAW touchscreen responds. In some implementations, the remote control device may start with the highest frequency that the remote control device is capable of transmitting and decrease the frequency for each subsequent pulse, or start at an arbitrary frequency that is neither the highest nor the lowest possible frequency and increase/decrease the frequency for subsequent pulses. In some implementations, the remote control device may stop increasing/decreasing the frequency when the SAW touchscreen acknowledges/responds to a pulse, and ultrasonic waves transmitted to simulate physically touching the SAW touchscreen at a desired area may be transmitted at the frequency of the pulse.

Instructions 412 may emit a focused light beam. A plurality of ultrasonic waves may be transmitted in a direction where the light beam is pointed. For example, instructions 412 may emit a laser beam (e.g., similar to a laser pointer) that a user may aim at a SAW touchscreen, and when the user presses a hard/soft key on the remote control device, a plurality of ultrasonic waves may be directed at a region of the SAW touchscreen illuminated by the laser beam. Any other type of focused light beam suitable for assisting a user in aiming ultrasonic waves may be used.

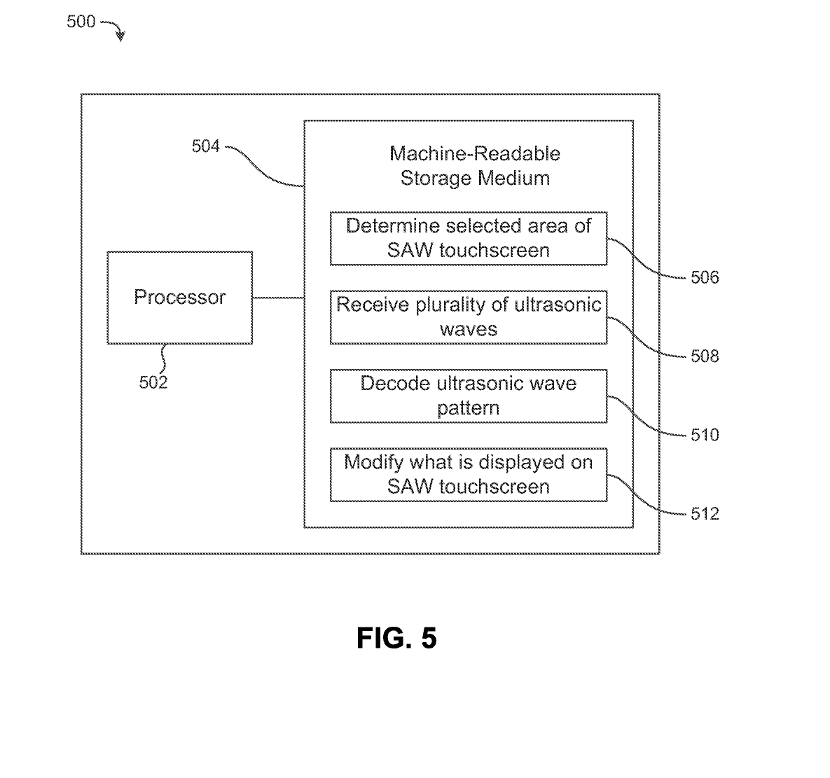

FIG. 5 is a block diagram of an example device 500 that includes a machine-readable storage medium encoded with instructions to decode an ultrasonic wave pattern to obtain data. Device 500 may include or be communicatively coupled to a SAW touchscreen. In FIG. 5, device 500 includes processor 502 and machine-readable storage medium 504.

As with processor 102 of FIG. 1, processor 502 may include a CPU, microprocessor (e.g., semiconductor-based microprocessor), and/or other hardware device suitable for retrieval and/or execution of instructions stored in machine-readable storage medium 504. Processor 502 may fetch, decode, and/or execute instructions 506, 508, 510, and 512. As an alternative or in addition to retrieving and/or executing instructions, processor 502 may include an electronic circuit comprising a number of electronic components for performing the functionality of instructions 506, 508, 510, and/or 512.

As with machine-readable storage medium 104 of FIG. 1, machine-readable storage medium 504 may be any suitable physical storage device that stores executable instructions, In some implementations, machine-readable storage medium 504 may include a non-transitory storage medium. As described in detail below, machine-readable storage medium 504 may be encoded with a set of executable instructions 506, 508, 510, and 512.

Instructions 506 may determine, based on a disruption of sound waves propagating across a SAW touchscreen, a selected area of the SAW touchscreen. The disruption may be caused by a first plurality of ultrasonic waves. The first plurality of ultrasonic waves may disrupt sound waves, that are propagating across the SAW touchscreen, in substantially the same manner as physically touching the SAW touchscreen at the selected area, as discussed above with respect to FIG. 1. The first plurality of ultrasonic waves may be transmitted at a first frequency.

Instructions 508 may receive a second plurality of ultrasonic waves. The second plurality of ultrasonic waves may include an ultrasonic wave pattern that encodes data. Data may include, for example, a URI, a message, and/or a command (e.g., to open/close an application, to bring the SAW touchscreen into or out of a sleep mode). The second plurality of ultrasonic waves may include waves transmitted at a second frequency and waves transmitted at a third frequency. In some implementations, the multiple frequencies may simulate binary code: the second frequency may represent logical ‘0’ and the third frequency may represent logical ‘1’, or vice-versa. In some implementations, the multiple frequencies may simulate a version of Morse code; the second frequency may represent a dot and the third frequency may represent a dash, or vice-versa.

Instructions 510 may decode the ultrasonic wave pattern to obtain the data. In some implementations, sensors on the SAW touchscreen may be tuned to listen for waves having the second and third frequencies, and/or other frequencies used to transmit data to the SAW touchscreen. When the sensors receive such waves, instructions 510 may convert the frequency information into, for example, binary or Morse code symbols, or any other suitable form for conveying URIs, textual messages, and/or commands. In some implementations, the second plurality of ultrasonic waves may disrupt waves, that are propagating across the

SAW touchscreen, in a different manner than physically touching the SAW touchscreen, and instructions 510 may recognize such disruptions as the conveyance of data rather than a selection of an area of the SAW touchscreen. In such implementations, different frequencies in the second plurality of ultrasonic waves may disrupt waves along the SAW touchscreen in different ways, and instructions 510 may determine which frequencies were transmitted that caused the disruptions, then convert the frequency information into, for example, binary or Morse code symbols, or any other suitable form for conveying URIs, textual messages, and/or commands.

Instructions 512 may modify, based on the data obtained by instructions 510, what is displayed on the SAW touchscreen. In some implementations, the SAW touchscreen may be a television screen and the data may include a command to change channels. Instructions 512 may display a different channel (e.g., the channel above or below the channel that was shown before the second plurality of ultrasonic waves was received, or a channel specified by the command). In some implementations, the data may include a textual message, and instructions 512 may display the message.

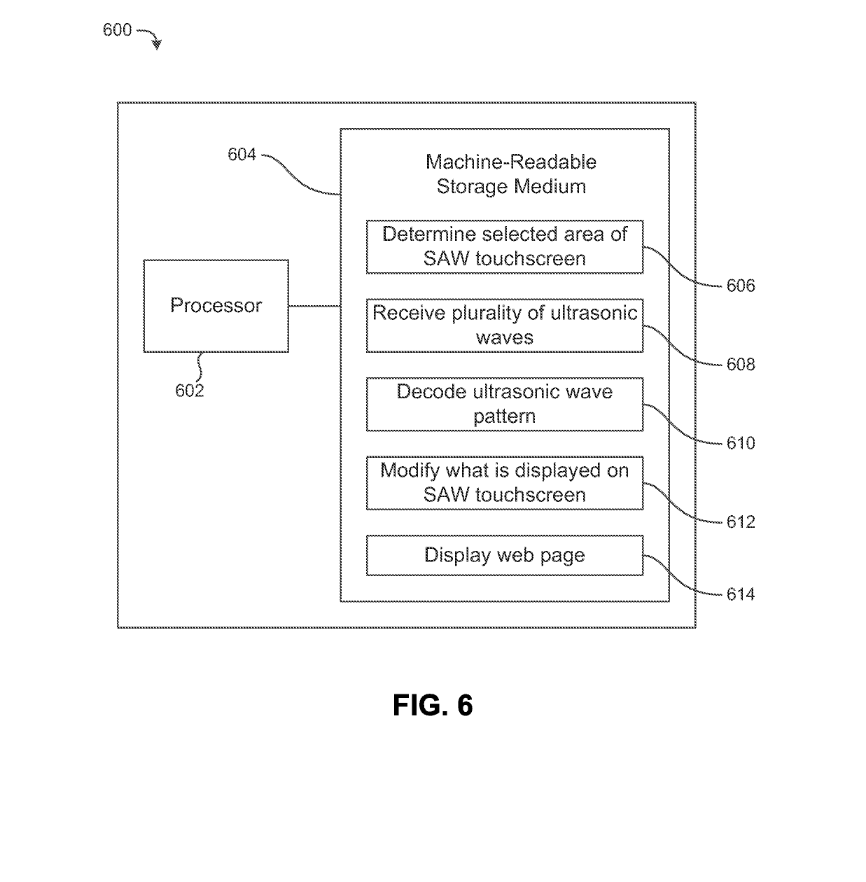

FIG. 6 is a block diagram of an example device 600 that includes a machine-readable storage medium encoded with instructions to enable displaying a web page in response to a decoded ultrasonic wave pattern. Device 600 may include or be communicatively coupled to a SAW touchscreen. In FIG. 6, device 600 includes processor 602 and machine-readable storage medium 604.

As with processor 502 of FIG. 5, processor 602 may include a CPU, microprocessor (e.g., semiconductor-based microprocessor), and/or other hardware device suitable for retrieval and/or execution of instructions stored in machine-readable storage medium 604. Processor 602 may fetch, decode, and/or execute instructions 606, 608, 610, 612, and 614 to enable displaying a web page in response to a decoded ultrasonic wave pattern, as described below. As an alternative or in addition to retrieving and/or executing instructions, processor 602 may include an electronic circuit comprising a number of electronic components for performing the functionality of instructions 606, 608, 610, 612, and/or 614.

As with machine-readable storage medium 504 of FIG. 5, machine-readable storage medium 604 may be any suitable physical storage device that stores executable instructions. Instructions 606, 608, 610, and 612 on machine-readable storage medium 604 may be analogous to instructions 506, 508, 510, and 512 on machine-readable storage medium 504. Instructions 610 may decode an ultrasonic wave pattern that encodes a URI. Instructions 614 may display a web page to which the URI refers. For example, the SAW touchscreen may display a window of a browser application, and instructions 614 may open a new window/tab and display the web page in the new window/tab.

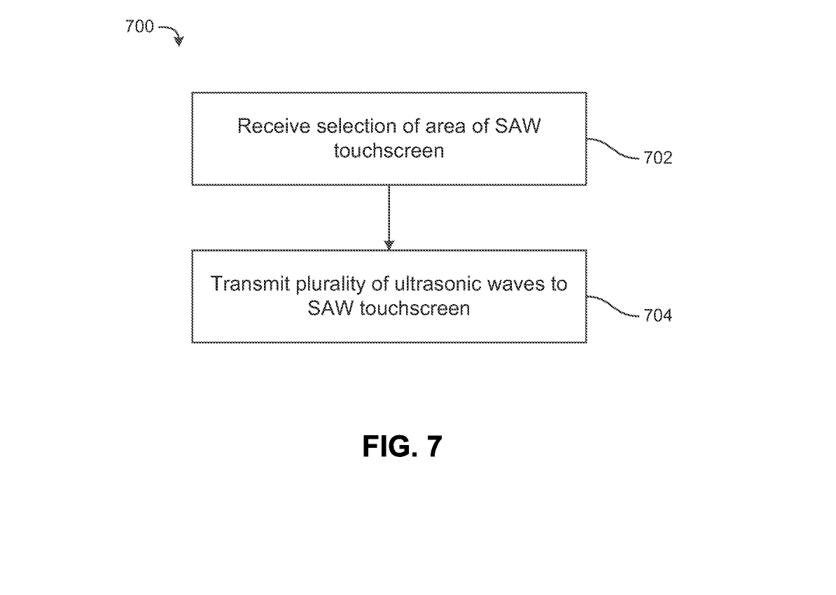

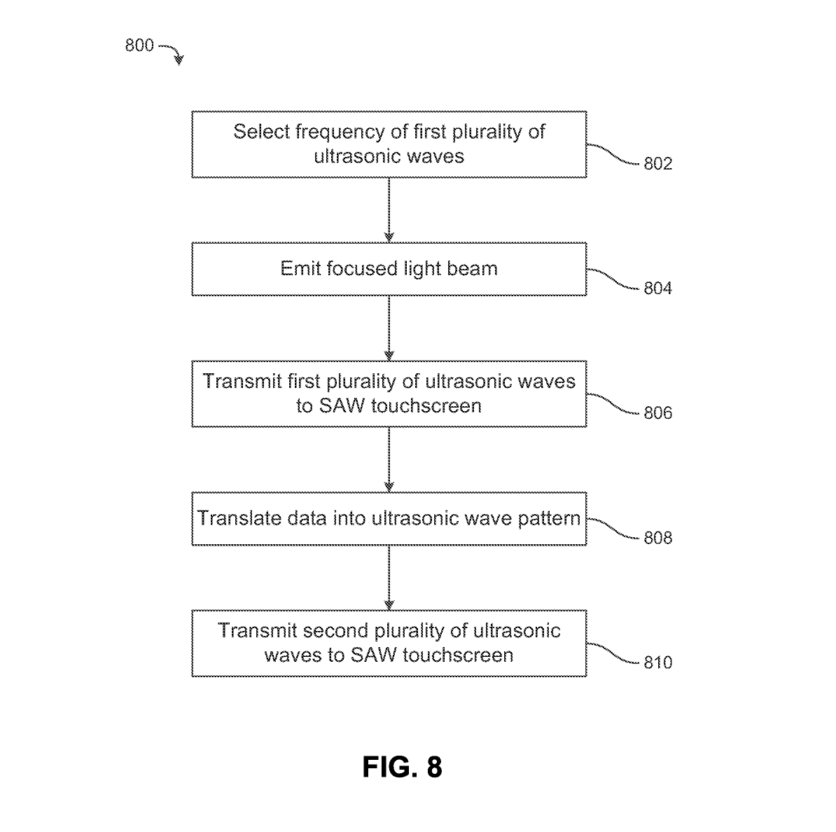

Methods related to using ultrasonic waves to control SAW touchscreens are discussed with respect to FIGS. 7-10. FIG. 7 is a flowchart of an example method 700 for interacting with SAW touchscreens. Although execution of method 700 is described below with reference to processor 102 of FIG. 1, it should be understood that execution of method 700 may be performed by other suitable devices, such as processors 202, 302, and 402 of FIGS. 2, 3, and 4, respectively. Method 700 may be implemented in the form of executable instructions stored on a machine-readable storage medium and/or in the form of electronic circuitry.

Method 700 may start in block 702, where processor 102 may receive a selection of an area of a SAW touchscreen. In some implementations, a user may point an ultrasonic emitter of a remote control device (e.g., remote control device 100) at an area of the SAW touchscreen. In some implementations, processor 102 may receive coordinates, entered using the remote control device, that specify a desired area of the SAW touchscreen. In some implementations, processor 102 may receive a selection of a corresponding region of a display of the remote control device, as discussed above with respect to FIG. 3.

Next, in block 704, processor 102 may transmit a plurality of ultrasonic waves to a SAW touchscreen. The plurality of ultrasonic waves may disrupt sound waves, that are propagating across the SAW touchscreen, in substantially the same manner as physically touching the SAW touchscreen at the selected area.

FIG. 8 is a flowchart of an example method 800 for sending data via ultrasonic waves to SAW touchscreens. Although execution of method 800 is described below with reference to processor 202 of FIG. 2, it should be understood that execution of method 800 may be performed by other suitable devices, such as processors 102 and 402 of AGS. 1 and 4, respectively. Some blocks of method 800 may be performed in parallel with and/or after method 700. Method 800 may be implemented in the form of executable instructions stored on a machine-readable storage medium and/or in the form of electronic circuitry.

Method 800 may start in block 802, where processor 202 may select a frequency of a first plurality of ultrasonic waves. The selected frequency may be in a range of frequencies to which a SAW touchscreen is responsive. In some implementations, processor 202 may transmit a series of ultrasonic pulses, starting with the lowest frequency that a remote control device (e.g., remote control device 200) is capable of transmitting and increasing the frequency for each subsequent pulse until the highest frequency that the remote control device is capable of transmitting is reached, and determine which frequency (or frequencies) the SAW touchscreen acknowledges and/or to which frequency (or frequencies) the SAW touchscreen responds. In some implementations, processor 202 may start with the highest frequency that the remote control device is capable of transmitting and decrease the frequency for each subsequent pulse, or start at an arbitrary frequency that is neither the highest nor the lowest possible frequency and increase/decrease the frequency for subsequent pulses. In some implementations, processor 202 may stop increasing/decreasing the frequency when the SAW touchscreen acknowledges/responds to a pulse.

In block 804, processor 202 may emit a focused light beam. The focused light beam may assist a user in aiming the first plurality of ultrasonic waves. For example, processor 202 may emit a laser beam (e.g., similar to a laser pointer) that a user may aim at a SAW touchscreen. Any other type of focused light beam suitable for assisting a user in aiming ultrasonic waves may be used.

Next, in block 806, processor 202 may transmit the first plurality of ultrasonic waves to the SAW touchscreen. For example, when a user presses a hard/soft key on a remote control device, processor 202 may direct the first plurality of ultrasonic waves at a region of the SAW touchscreen illuminated by the focused light beam emitted in block 804. The first plurality of ultrasonic waves may disrupt sound waves, that are propagating across the SAW touchscreen, in substantially the same manner as physically touching the SAW touchscreen at the area illuminated by the focused light beam.

In block 808, processor 202 may translate data into an ultrasonic wave pattern. Data may include, for example, a URI, a message, and/or a command (e.g., to open/close an application, to bring the SAW touchscreen into or out of a sleep mode). The ultrasonic wave pattern may include multiple frequencies (e.g., frequency modulation may be used to encode data). In some implementations, the multiple frequencies may simulate binary code or a version of Morse code, as discussed above with respect to FIG. 2.

Finally, in block 810, processor 202 may transmit a second plurality of ultrasonic waves to the SAW touchscreen. The second plurality of ultrasonic waves may include the ultrasonic wave pattern discussed above with respect to block 808. In some implementations, the second plurality of ultrasonic waves may be used to transmit a URI (e.g., the URI may be encoded in an ultrasonic wave pattern in the second plurality of ultrasonic waves) to the SAW touchscreen. The SAW touchscreen may display, in response to receiving the second plurality of ultrasonic waves, a web page to which the URI refers.

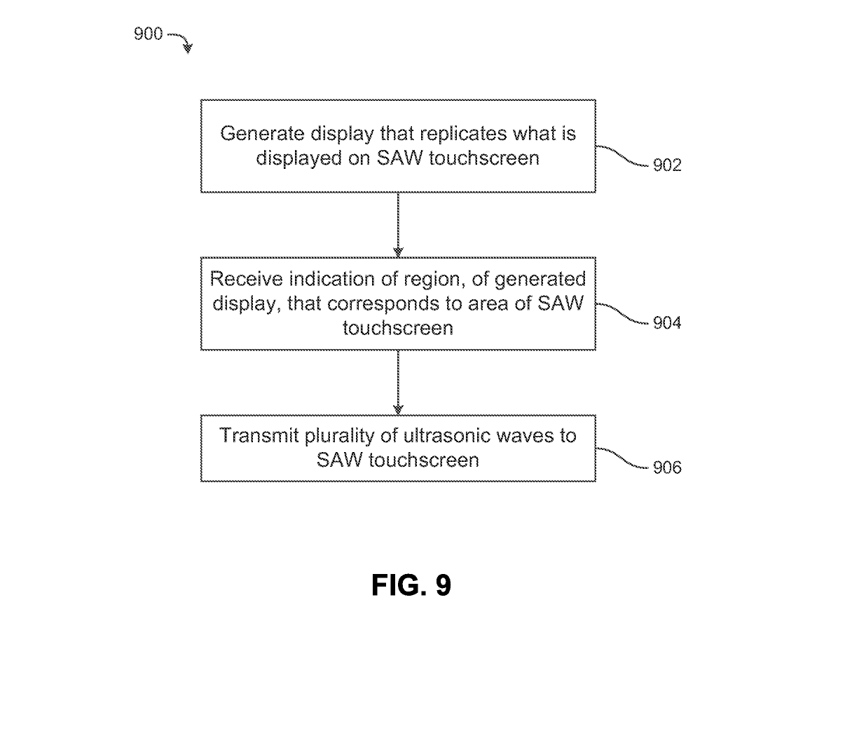

FIG. 9 is a flowchart of an example method 900 for automatically directing ultrasonic waves at a desired area of a SAW touchscreen. Although execution of method 900 is described below with reference to processor 302 of FIG. 3, it should be understood that execution of method 900 may be performed by other suitable devices, such as processor 102 of FIG. 1. Some blocks of method 900 may be performed in parallel with and/or after method 700. Method 900 may be implemented in the form of executable instructions stored on a machine-readable storage medium and/or in the form of electronic circuitry.

Method 900 may start in block 902, where processor 302 may generate a display that replicates what is displayed on a SAW touchscreen. For example, processor 302 may generate, for display on a remote control device (e.g., remote control device 300), what looks like a screen shot of what is displayed on the SAW touchscreen. In some implementations, due to differences in display capabilities between the SAW touchscreen and the remote control device, the resolution and/or aspect ratio of what is displayed on the remote control device may be different from what is displayed on the SAW touchscreen.

Next, in block 904, processor 302 may receive an indication of a region, of the generated display, that corresponds to an area of the SAW touchscreen. For example, various icons displayed on the SAW touchscreen may also be displayed on the remote control device, and a user may select (e.g., using a finger, stylus, or cursor), on the display of the remote control device, an icon that corresponds to the icon the user desires to select on the SAW touchscreen. In some implementations, the remote control device may display a screen shot of what is displayed on the SAW touchscreen, and a user may select (e.g., using a finger, stylus, or cursor) a region of the screen shot that corresponds to an area of the SAW touchscreen that the user desires to select.

Finally, in block 906, processor 302 may transmit a plurality of ultrasonic waves to the SAW touchscreen. In some implementations, processor 302 may automatically direct a plurality of ultrasonic waves at the area of the SAW touchscreen corresponding to the indicated region. For example, after a user selects an icon/region on a display of the remote control device, processor 302 may automatically transmit, without further action from the user (e.g., without the user having to press a hard/soft key to initiate transmission of the ultrasonic waves), a plurality of ultrasonic waves directed at the corresponding area of the SAW touchscreen. In some implementations, processor 302 may determine (e.g., using a camera and/or wireless signals) where the SAW touchscreen is in relation to an ultrasonic emitter of the remote control device, and may automatically focus and transmit the plurality of ultrasonic waves at the appropriate area of the SAW touchscreen without the user having to aim the remote control device. The transmitted plurality of ultrasonic waves may disrupt sound waves, that are propagating across the SAW touchscreen, in substantially the same manner as physically touching the SAW touchscreen at the area corresponding to the indicated region of the generated display.

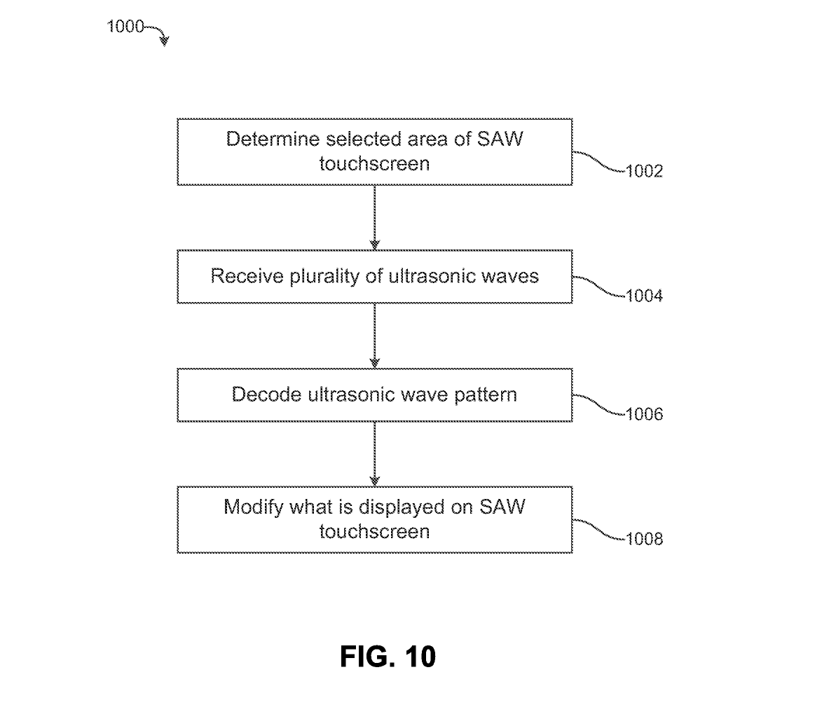

FIG. 10 is a flowchart of an example method 1000 for modifying, based on data encoded in ultrasonic waves, what is displayed on a SAW touchscreen. Although execution of method 1000 is described below with reference to processor 502 of FIG. 5, it should be understood that execution of method 1000 may be performed by other suitable devices, such as processor 602 of FIG. 6. Method 1000 may be implemented in the form of executable instructions stored on a machine-readable storage medium and/or in the form of electronic circuitry.

Method 1000 may start in block 1002, where processor 502 may determine, based on a disruption of sound waves propagating across a SAW touchscreen, a selected area of the SAW touchscreen. The disruption may be caused by a first plurality of ultrasonic waves. The first plurality of ultrasonic waves may disrupt sound waves, that are propagating across the SAW touchscreen, in substantially the same manner as physically touching the SAW touchscreen at the selected area, as discussed above with respect to FIG. 1. The first plurality of ultrasonic waves may be transmitted at a first frequency.

In block 1004, processor 502 may receive a second plurality of ultrasonic waves. The second plurality of ultrasonic waves may include an ultrasonic wave pattern that encodes data. Data may include, for example, a URI, a message, and/or a command (e.g., to open/close an application, to bring the SAW touchscreen into or out of a sleep mode). The second plurality of ultrasonic waves may include waves transmitted at a second frequency and waves transmitted at a third frequency. In some implementations, the multiple frequencies may simulate binary code or a version of Morse code, as discussed above with respect to FIG, 2.

Next, in block 1006, processor 502 may decode the ultrasonic wave pattern to obtain the data. In some implementations, processor 502 may detect various frequencies in the ultrasonic wave pattern and convert the frequency information into, for example, binary or Morse code symbols, or any other suitable form for conveying URIs, textual messages, and/or commands. In some implementations, processor 502 may recognize disruptions of waves propagating across the SAW touchscreen as the conveyance of data rather than a selection of an area of the SAW touchscreen, as discussed above with respect to FIG. 5. In such implementations, processor 502 may determine which frequencies were transmitted that caused the disruptions, then convert the frequency information into, for example, binary or Morse code symbols, or any other suitable form for conveying URIs, textual messages, and/or commands.

Finally, in block 1008, processor 502 may modify, based on the data in the ultrasonic wave pattern, what is displayed on the SAW touchscreen, In some implementations, the data may include a URI (e.g., the URI may be encoded in an ultrasonic wave pattern in the second plurality of ultrasonic waves). Processor 502 may generate, in response to receiving the second plurality of ultrasonic waves, a display of a web page to which the URI refers,

The foregoing disclosure describes remote interaction with SAW touchscreens. Example implementations described herein enable users with limited physical mobility or reach to interact with SAW touchscreens without physically touching them. Thus, SAW touchscreens may appeal to a broader base of users, expanding the market for SAW touchscreens.

We claim:

1. A method of interacting with a surface acoustic wave (SAW) touchscreen, the method comprising:
receiving a selection of an area of the SAW touchscreen; and
transmitting a first plurality of ultrasonic waves to the SAW touchscreen, wherein the first plurality of ultrasonic waves disrupt sound waves, that are propagating across the SAW touchscreen, in substantially the same manner as physically touching the SAW touchscreen at the selected area.

2. The method of claim 1, further comprising:
translating data into an ultrasonic wave pattern; and
transmitting a second plurality of ultrasonic waves to the SAW touchscreen, wherein the second plurality of ultrasonic waves comprise the ultrasonic wave pattern.

3. The method of claim 2, wherein:
the data comprises a uniform resource identifier (URI); and
the SAW touchscreen displays, in response to receiving the second plurality of ultrasonic waves, a web page to which the URI refers.

4. The method of claim 1, further comprising generating a display that replicates what is displayed on the SAW touchscreen, wherein:
receiving the selection of the area comprises receiving an indication of a region, of the generated display, that corresponds to the area of the SAW touchscreen; and
the transmitted first plurality of ultrasonic waves are automatically directed at the area of the SAW touchscreen.

5. The method of claim 1, further comprising emitting a focused light beam, wherein the first plurality of ultrasonic waves are transmitted in a direction where the focused light beam is pointed.

6. The method of claim 1, further comprising selecting a frequency of the first plurality of ultrasonic waves, wherein the selected frequency is in a range of frequencies to which the SAW touchscreen is responsive.

7. A machine-readable storage medium encoded with instructions executable by a processor of a remote control device for interacting with a surface acoustic wave (SAW) touchscreen, the machine-readable storage medium comprising:
instructions to receive a selection of an area of the SAW touchscreen; and
instructions to transmit a first plurality of ultrasonic waves to the SAW touchscreen, wherein the first plurality of ultrasonic waves disrupt sound waves, that are propagating across the SAW touchscreen, in substantially the same manner as physically touching the SAW touchscreen at the selected area.

8. The machine-readable storage medium of claim 7, further comprising:
instructions to translate data into an ultrasonic wave pattern; and
instructions to transmit a second plurality of ultrasonic waves to the SAW touchscreen, wherein the second plurality of ultrasonic waves comprise the ultrasonic wave pattern.

9. The machine-readable storage medium of claim 8, wherein:
the data comprises a uniform resource identifier (URI); and
the SAW touchscreen displays, in response to receiving the second plurality of ultrasonic waves, a web page to which the URI refers.

10. The machine-readable storage medium of claim 7, further comprising:
instructions to generate a display that replicates what is displayed on the SAW touchscreen;
instructions to receive an indication of a region, of the generated display, that corresponds to the area of the SAW touchscreen; and
instructions to automatically direct the first plurality of ultrasonic waves at the area of the SAW touchscreen.

11. The machine-readable storage medium of claim 7, further comprising instructions to emit a focused light beam, wherein the first plurality of ultrasonic waves are transmitted in a direction where the light beam is pointed.

12. The machine-readable storage medium of claim 7, further comprising instructions to select a frequency of the first plurality of ultrasonic waves, wherein the selected frequency is in a range of frequencies to which the SAW touchscreen is responsive.

13. A machine-readable storage medium encoded with instructions executable by a processor communicatively coupled to a surface acoustic wave (SAW) touchscreen, the machine-readable storage medium comprising:
instructions to determine, based on a disruption of sound waves propagating across the SAW touchscreen, a selected area of the SAW touchscreen, wherein the disruption is caused by a first plurality of ultrasonic waves;
instructions to receive a second plurality of ultrasonic waves, wherein the second plurality of ultrasonic waves comprise an ultrasonic wave pattern that encodes data;
instructions to decode the ultrasonic wave pattern to obtain the data; and
instructions to modify, based on the data, what is displayed on the SAW touchscreen.

14. The machine-readable storage medium of claim 13, wherein the data comprises a uniform resource identifier (URI), the machine-readable storage medium further comprising instructions to display a web page to which the URI refers.

15. The machine-readable storage medium of claim 13, wherein:
the first plurality of ultrasonic waves are transmitted at a first frequency; and
the second plurality of ultrasonic waves comprise waves transmitted at a second frequency and waves transmitted at a third frequency.
